(19) United States
(12) Patent Application Publication
(10) Pub. No.: US 2005/0077788 A1
(43) Pub. Date: Apr. 14, 2005

(54) Collector device and motor

(76) Inventors: Shigekazu Kieda, Ishioka (JP); Itsurou Sawada, Chiyoda (JP); Kenichi Hattori, Hitachi (JP); Shigeki Nakae, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/851,144

(22) Filed: May 24, 2004

(30) Foreign Application Priority Data
Oct. 10, 2003 (JP) 2003-352518

(51) Int. Cl. H02K 9/00; H02K 1/00

(52) U.S. Cl. 310/58; 310/232

(57) ABSTRACT

In a collector device for supplying an electric power to a rotor of a motor with a cooling by a cooling medium, an annular collector electrode is fixed to the rotor to supply the electric power to the rotor through a cylindrical outer surface of the collector electrode, an electrically conductive brush is contactable with the cylindrical outer surface of the collector electrode to supply the electric power to the collector electrode, and a cooling medium outlet opens to at least partially face to the collector electrode in such a manner that the cooling medium is supplied from the outlet to the collector electrode in each of circumferential directions of the rotor opposed to each other circumferentially to be divided into two flow parts in respective circumferential directions of the rotor opposed to each other circumferentially.

### BACKGROUND OF THE INVENTION

The present invention relates to a collector device for supplying an electric power to a rotor of a motor with a cooling by a cooling medium, and the motor with the collector device.

JP-A-6-197496 discloses a collector device in which a cooling air is directed by a guide member to two collector electrode rings.

Page 66 of Den-netsu-Kougaku-Shiryou 4^{th} edition edited by Nihon-Kikai-Gakkai on 1986 discloses that a cooling efficiency is increased by using a jet flow.

### BRIEF SUMMARY OF THE INVENTION

An object of the present invention is to provide a collector device for supplying an electric power to a rotor of a motor with a cooling by a cooling medium in which collector device a cooling efficiency for an collector electrode is increased, and a motor with the collector device.

According to the invention, a collector device for, with a cooling by a cooling medium, at lease one of supplying an electric power to a rotor of a motor from the collector device and supplying the electric power from the rotor of the motor to the collector device, comprises, an annular collector electrode fixed to the rotor and having a cylindrical outer surface of the collector electrode, an electrically conductive brush contactable with the cylindrical outer surface of the collector electrode to transmit the electric power between the rotor and the electrically conductive brush through the collector electrode when the rotor rotates, and a cooling medium outlet (member) opening to at least partially face to the collector electrode in such a manner that the cooling medium is supplied from the outlet to the collector electrode in each of circumferential directions of the rotor opposed to each other circumferentially to be divided into two flow parts in respective circumferential directions of the rotor opposed to each other circumferentially.

If the outlet and the collector electrode are arranged (a positional relationship therebetween is set) in such a manner that a flow rate of the cooling medium supplied toward the collector electrode at a first side of the outlet from which first side the collector electrode is movable circumferentially over the outlet toward a second side of the outlet opposite to the first side in the circumferential direction of the rotor (through a radially central (intermediate) position of the outlet) is greater than a flow rate of the cooling medium supplied toward the collector electrode at the second side of the outlet toward which second side the collector electrode is movable circumferentially from the first side of the outlet (through the radially central (intermediate) position of the outlet), a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased. (Incidentally, a representative flow direction (central flow axis) of the whole of the cooling medium flowing out of and directed by the outlet passes the radially central (intermediate) position of the outlet.)

If the outlet and the collector electrode are arranged (a positional relationship therebetween is set) in such a manner that an opening area for a flow of the cooling medium between the outlet and the collector electrode in one of the circumferential directions at a first side of the outlet from which first side the collector electrode is movable circumferentially toward a second side of the outlet opposite to the first side over the outlet in the circumferential direction of the rotor (through a radially central (intermediate) position of the outlet) is greater than an opening area for the flow of the cooling medium between the outlet and the collector electrode in the other one of the circumferential directions at the second side of the outlet toward which second side the collector electrode is movable circumferentially from the first side of the outlet (through the radially central (intermediate) position of the outlet) (for example, a radial distance between the outlet and the collector electrode at the first side of the outlet is greater than a radial distance between the outlet and the collector electrode at the second side, and/or an axial length between the outlet and the collector electrode radially facing to each other at the first side of the outlet is greater than an axial length between the outlet and the collector electrode radially facing to each other at the second side of the outlet) so that the flow rate of the cooling medium supplied toward the collector electrode in the one of the circumferential directions at (from) the first side of the outlet is greater than the flow rate of the cooling medium supplied toward the collector electrode in the other one of the circumferential direction at (from) the second side of the outlet, a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased.

If the outlet and the collector electrode are arranged in such a manner that a representative flow direction (central flow axis) of the whole of the cooling medium flowing out of and directed by the outlet is prevented from passing a radial center (rotational axis) of the rotor in such a manner that the flow rate of the cooling medium supplied toward the collector electrode in the one of the circumferential directions at (from) the first side of the outlet is greater than the flow rate of the cooling medium supplied toward the collector electrode in the other one of the circumferential direction at (from) the second side of the outlet, a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased.

If the outlet and the collector electrode are arranged in such a manner that a representative flow direction (direction of central flow) of the whole of the cooling medium flowing out of and directed by the outlet and a circumferential moving direction of the collector electrode at a circumferential position of the outer surface of the collector electrode which circumferential position is passed by the representative flow direction are opposed to each other (that is, a component of the representative flow direction parallel to a tangential direction of the circumferential moving direction at the circumferential position is opposed to a tangential component of the circumferential moving direction at the circumferential position so that a difference between a moving speed of the outer surface of the collector electrode and a flowing speed of the cooling medium, that is, a relative speed between the outer surface of the collector electrode and the cooling medium is increased, and/or the flow rate of the cooling medium supplied toward the collector electrode in the one of the circumferential directions at (from) the first side of the outlet is greater than the flow rate of the cooling medium supplied toward the collector electrode in the other one of the circumferential direction at (from) the second side of the outlet), a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased.

If a minimum distance in a radial direction of the rotor between the collector electrode and a part of the outlet facing to each other in the radial direction at a first side of the outlet from which first side the collector electrode is movable circumferentially over the outlet toward a second side of the outlet opposite to the first side in the circumferential directions of the rotor (through a radially central (intermediate) position of the outlet) is greater than a minimum distance in the radial direction between the collector electrode and another part of the outlet facing to each other in the radial direction at the second side of the outlet toward which second side the collector electrode is movable circumferentially from the first side of the outlet (through the radially central (intermediate) position of the outlet) so that the flow rate of the cooling medium supplied toward the collector electrode in the one of the circumferential direction at (from) the first side of the outlet is greater than the flow rate of the cooling medium supplied toward the collector electrode in the other one of the circumferential direction at (from) the second side of the outlet, a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased.

If a distance in a radial direction of the rotor between the collector electrode and each of terminating ends of the outlet (which terminating ends are opposed to each other) in an axial direction of the rotor is greater than a distance in the radial direction between the collector electrode and the outlet at an intermediate (preferably, central) position of the outlet between the terminating ends in the axial direction at at least one of a first side of the outlet from which first side the collector electrode is movable circumferentially over the outlet toward a second side of the outlet opposite to the first side in the circumferential directions of the rotor (through a radially central (intermediate) position of the outlet) and the second side of the outlet toward which second side the collector electrode is movable circumferentially from the first side of the outlet (through the radially central-(intermediate) position of the outlet), the cooling medium is restrained from flowing in the axial direction and directed strongly in the circumferential direction so that a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased.

If the collector device comprises a pair of the collector electrodes and a pair of the outlets for the respective collector electrodes, and a distance in a radial direction of the rotor between the collector electrode and one of the outlets at one of terminating ends of the one of the outlets (which terminating ends are opposed to each other) in an axial direction of the rotor is smaller than a distance in the radial direction between the collector electrode and each of the outlets at an intermediate (preferably, central) position of the each (respective one) of the outlets in the axial direction between the terminating ends of the each (respective one) of the outlets in the axial direction at a side of the each (respective one) of the outlets toward which side the collector electrode is movable circumferentially over the outlet from a radially central (intermediate) position of the each (respective one) of the outlets, the cooling medium is restrained from flowing in the axial direction and directed strongly in the circumferential direction so that a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased. If the one of terminating ends of the one of the outlets is arranged between two of the terminating ends of the outlets in the axial direction of the rotor, the one of terminating ends of the one of the outlets restrains the cooling mediums from the respective outlets from interfering with each other so that the cooling mediums is restrained from being directed in the axial direction.

If in a cross sectional view of the outlet taken along an imaginary plane perpendicular to an axial direction of the rotor, the outlet has a first inner surface (at a terminating end of the outlet) at a first side of the outlet from which first side the collector electrode is movable circumferentially toward a second side of the outlet opposite to the first side in the circumferential directions of the rotor (through a radially central (intermediate) position of the outlet) and a second inner surface (at another terminating end of the outlet) at the second side of the outlet toward which second side the collector electrode is movable circumferentially from the first side of the outlet (through the radially central (intermediate) position of the outlet), and when a distance between each of the first and second inner surfaces and a measuring location on an imaginary straight line passing a radially central position of the outlet and a rotary axis of the rotor is measurable in a distance measuring direction perpendicular to the imaginary straight line, a rate of increase in the distance between the first inner surface and the measuring location with respect to a decrease in distance between the measuring location and the outer surface of the collector electrode along the imaginary straight line is greater than a rate of increase in the distance between the second inner surface and the measuring location with respect to the decrease in distance between the measuring location and the outer surface of the collector electrode along the imaginary straight line, the cooling medium reaching the outer peripheral surface of the collector electrode at the first side is restrained from being separated from the outer peripheral surface of the collector electrode in the radial direction of the rotor so that an heat exchange (cooling) between the cooling medium and the outer peripheral surface of the collector electrode (cooling of the outer peripheral surface of the collector electrode by the cooling medium) is securely maintained at the first side.

If the collector electrode and at least one of terminating ends of the outlet (which terminating ends are opposed to each other) in an axial direction of the rotor overlap each other at least partially as seen in the axial direction of the rotor, the cooling medium is restrained from flowing in the axial direction from the collector electrode and directed strongly in the circumferential direction so that a flow rate of a part of the cooling medium with a relatively greater relative speed between the cooling medium and the outer peripheral surface of the collector electrode is made greater than a flow rate of another part of the cooling medium with a relatively smaller relative speed between the cooling medium and the outer peripheral surface of the collector electrode so that a cooling efficiency for the collector electrode is increased.

An electric motor for generating a rotary output power from an electric power supplied to the motor with a cooling by a cooling medium, comprises, a rotor capable of being rotationally driven by the electric power to generate the rotary output power, an annular collector electrode fixed to the rotor to supply the electric power to the rotor through a cylindrical outer surface of the collector electrode, an electrically conductive brush contacting the cylindrical outer surface of the collector electrode to supply the electric power to the collector electrode, and a cooling medium outlet (member) opening to at least partially face to the collector electrode in such a manner that the cooling medium is supplied from the outlet to the collector electrode in each of circumferential directions of the rotor opposed to each other circumferentially to be divided into two flow parts in respective circumferential directions of the rotor opposed to each other circumferentially.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a partially cross sectional view showing an embodiment of the invention.

FIG. 2 is a partially cross sectional view of the embodiment taken along a line II-II in FIG. 1.

FIG. 3 is a partially cross sectional view of a comparative example of a collector device.

FIG. 4 is a partially cross sectional view of another embodiment of the invention.

FIG. 5 is a partially cross sectional view of another embodiment of the invention.

FIG. 6 is a partially cross sectional view showing another embodiment of the invention.

FIG. 7 is a partially cross sectional view of the another embodiment taken along a line VII-VII in FIG. 6.

FIG. 8 is a partially cross sectional view of a comparative example of a collector device.

FIG. 9 is a partially cross sectional view of another embodiment of the invention.

FIG. 10 is a partially cross sectional view of another embodiment of the invention.

### DETAILED DESCRIPTION OF THE INVENTION

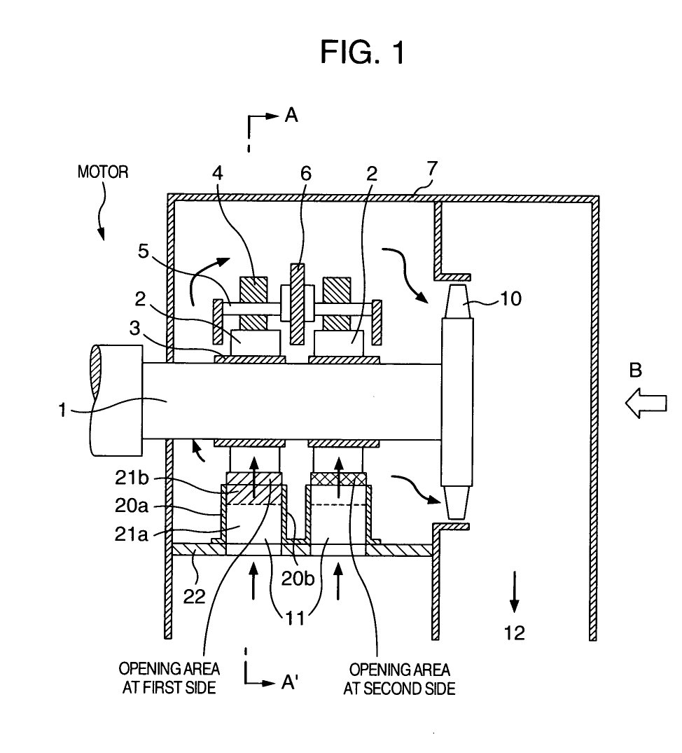

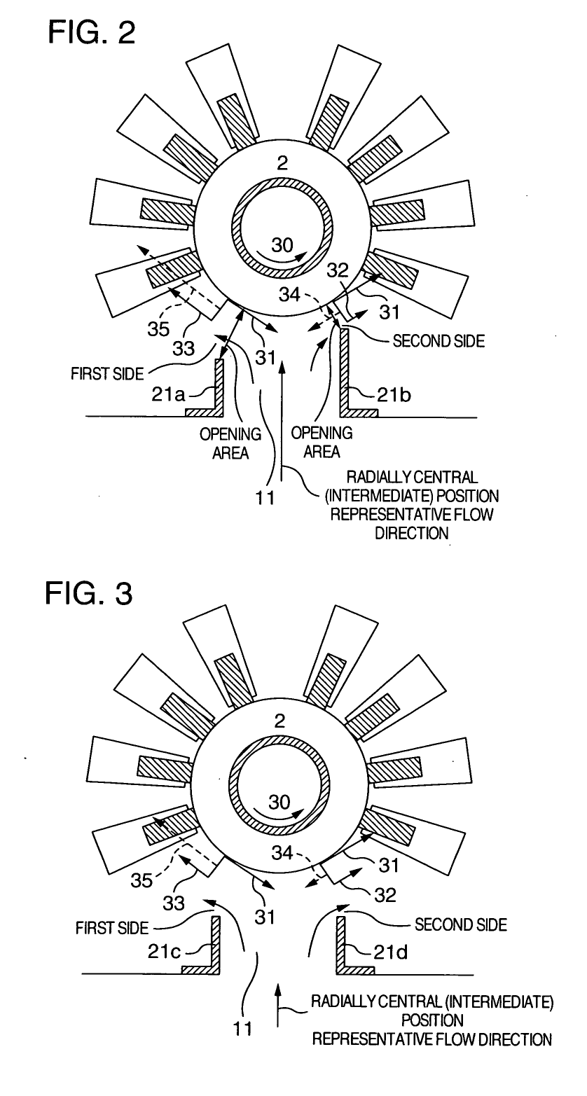

As shown in FIGS. 1 and 2, a pair of positive voltage collector electrode and negative voltage collector electrode rings 2 are mounted on a rotor shaft 1. An insulating member 3 is arranged for an electrical insulation between the shaft 1 and the collector electrodes rings 2. Brushes 4 contact the collector electrode rings 2 to slide thereon to supply an electric current. The brushes are juxtaposed circumferentially and axially and held by a brush holder 5. A cover 7 covers a collector device. The brushes need to be maintained and replaced for abrasion. Therefore, all of the brushes 4 are arranged at substantially an upper half of the collector electrode rings 2 so that maintenance operation can be done from upper portion and side face of the cover 7. Further, an insulating protect plate 6 is arranged between the brushes 4 to maintain a safety on doing maintenance of the brushes and to prevent the collector electrodes rings from being connected electrically to each other. A cooling air is driven by a fan 10 mounted on the rotor shaft 1, and the cover 7 includes inlet 11 and outlet 12 for the cooling air. The inlet 11 for the cooling air is arranged at a lower side at which the brushes 4 are not arranged so that the collector electrode rings are cooled directly.

20a and 20b denote control plates for controlling an axial flow of the cooling air (a pair of plates constituting the control plates 20 for controlling the axial flow) to be mounted on a mounting plate 22 mounted on the cover 7. Further, 21a and 21b denote control plates for controlling a circumferential flow of the cooling air (a pair of plates constituting the control plates 21 for controlling the circumferential flow) to be mounted on the mounting plate 22 mounted on the cover 7. Therefore, the control plates 21 and 22 form a nozzle of rectangular tube shape. Incidentally, in FIG. 1, the position of the control plate 21a is denoted by a dot line for convenience for explanation.

As shown in the drawings, a distance between the control plate 21a arranged at an upstream side of the rotational direction and a surface of the collector electrode rings 2 is made greater than a distance between the control plate 21b arranged at a downstream side of the rotational direction and the surface of the collector electrode rings 2.

In this embodiment, since the control plates 21a and 21b are arranged as described above, a flow of the cooling air for cooling an outer peripheral surface of the collector electrode rings is increased at the downstream side of the rotational direction of the rotary shaft (right side in the drawing) in comparison with the upstream side of the rotational direction of the rotary shaft (left side in the drawing).

In FIG. 2, the collector electrode rings 2 rotate in a direction of an arrow 30, and their circumferential speed is 31. As shown here, since the collector electrode rings 2 rotate, a value of cooling capacity for the collector electrode rings 2 depends on a value of relative speed between the collector electrode ring surface and the cooling air. Further, this relative speed is differentiated between the upstream and downstream sides of the rotational direction as seen from a jet flow central axis between the flow control plates 21a and 21b. That is, a relative speed 35 at the upstream side of the rotational direction and a relative speed 34 at the downstream side of the rotational direction are differential values in which the circumferential speed 31 of the collector electrode rings 2 are taken respectively from a jet flow speed 33 toward the upstream side of the rotational direction and a jet flow speed 32 toward the downstream side of the rotational direction. As understandable from FIG. 2, the relative speed 34 at the downstream side of the rotational direction is smaller than the relative speed 35 at the upstream side of the rotational direction so that the cooling capacity is higher at the upstream side of the rotational direction.

FIG. 3 is a drawing showing a comparative example. As shown in the drawing, the distance between the control plate 21c arranged at the upstream side of the rotational direction and the surface of the collector electrode rings 2 is equal to the distance between the control plate 21d arranged at the downstream side of the rotational direction and the surface of the collector electrode rings 2. As understood from a comparison between FIGS. 2 and 3, the jet flow speed 33 toward the upstream side of the rotational direction in FIG. 2 is increased in comparison FIG. 3 to increase the relative speed 35 so that the cooling capacity is increased. Further, the jet flow speed 32 toward the downstream side of the rotational direction is decreased in comparison FIG. 3 to increase the relative speed 34. Therefore, cooling capacity at the downstream side of the rotational direction is increased.

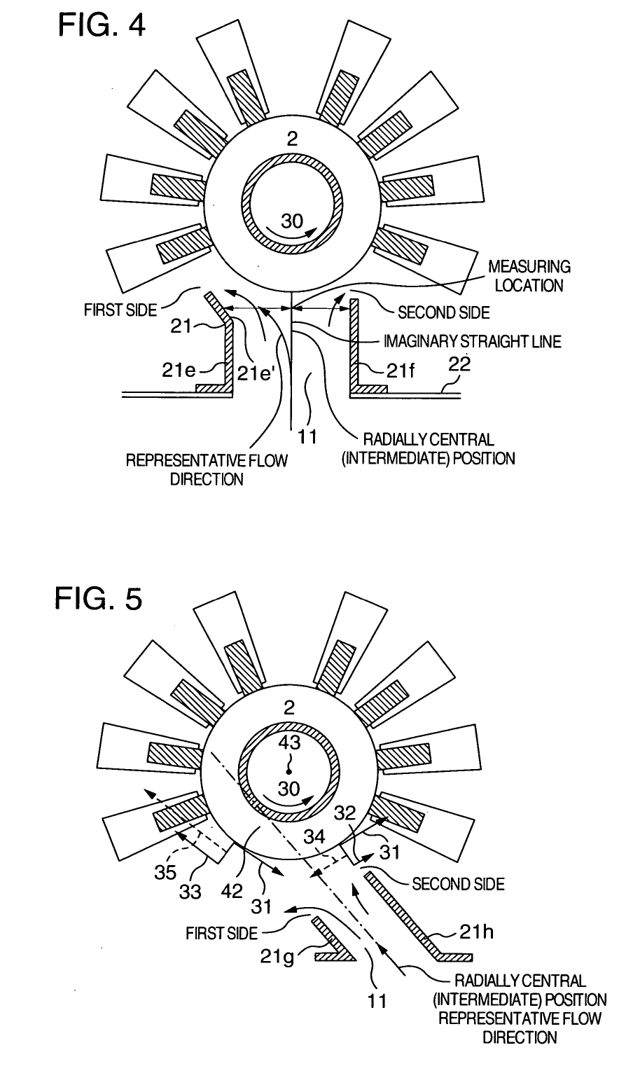

FIG. 4 is a drawing for explanation of another embodiment of the invention. As shown in the drawing, a control plate 21e arranged at the upstream side of the rotational direction and the control plate 21d arranged at the downstream side of the rotational direction are incorporated. Further, a bent portion 21e′ as an upper portion of the control plate 21e bent outward is formed at the upper portion of the control plate 21e. Further, heights of the control plate 21e including the bent portion 21e′ and the control plate 21f on the mounting plate 22 are substantially equal to each other.

By this structure, in addition to the function and effect shown in the embodiment of FIG. 2, a flow toward the upstream side of the rotational direction of the collector electrode rings is prevented from being separated from the collector rings so that a flow rate in the vicinity of the surface of the collector electrode rings is further increased.

FIG. 4 is a drawing for explanation of another embodiment of the invention. In the above description, cases in which a rotational axis 43 of the collector electrode rings 2 is arranged on an extension line of the central axis of the jet flow. In contrast, in the embodiment of FIG. 5, the extension line 42 of the jet flow is shifted from the center 43 of the rotary shaft toward the upstream side of the rotational direction.

By this arrangement, a flow passage resistance of a flow passage for the jet flow toward the upstream side of the rotational direction is decreased in comparison with a flow passage resistance of a flow passage for the jet flow toward the downstream side of the rotational direction. Therefore, the flow rate and relative speed 35 of the flow passage toward the upstream side of the rotational direction is increased to improve the cooling capacity. Further, in consideration on a substantive cooling surface area of the collector electrode rings at which the brushes are not arranged, an area at the upstream side of the rotational direction from a position at which the center of the jet flow collides with the collector electrode rings is greater than an area at the downstream side of the rotational direction therefrom. Therefore, it is further advantageous for improving the cooling capacity.

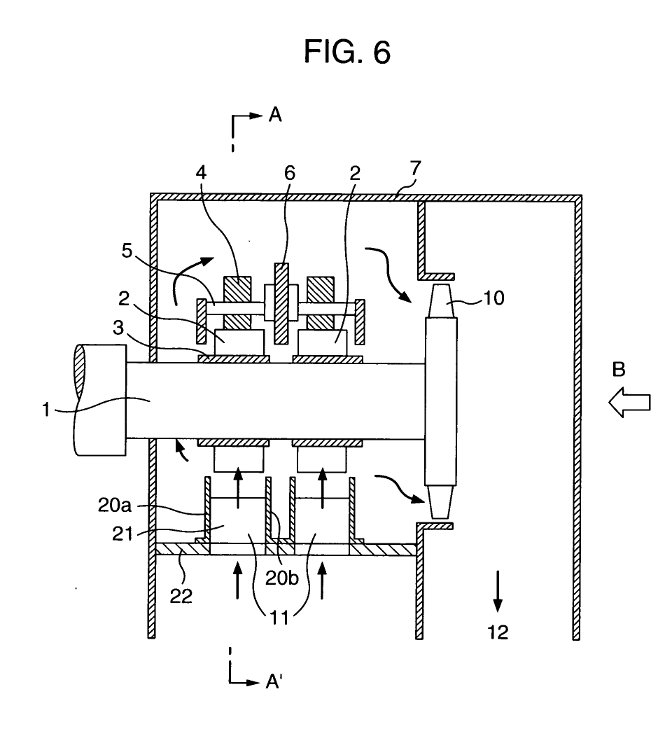

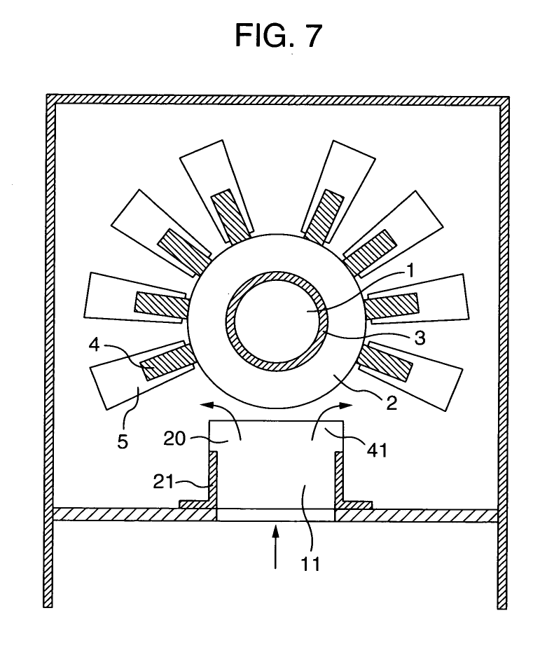

FIGS. 6 and 7 are drawings for explanations of another embodiments, FIG. 6 is a longitudinally cross sectional view, and FIG. 7 is a cross sectional view of A-A′ cross section seen in B direction in FIG. 6. In the above description, a circumferential cooling is explained. On the other hand, the cooling air flows not only in the circumferential direction, but also in the axial direction. Therefore, the cooling air needs to be guided to flow mainly in the circumferential direction. FIGS. 6 and 7 are views for explaining a structure for guiding the cooling air toward the circumferential direction.

In these drawings, 20a and 20b denote control plates of flow for controlling the flow of the cooling air (a pair of plates constituting control plates 20 for controlling the axial flow). By making a height of the control plates 20 on the mounting plate 22 higher than a height of the control plates 21, a major part of the flow flowing in from the inlet 11 can be directed into the circumferential direction of the collector electrode rings 2. By forming the control plates 20 and 21 in this manner, the flow rate in the circumferential direction is increased in comparison with the axial direction so that the effect on the jet flow cooling is increased. Incidentally, upper end surfaces 41 of the control plates 20 do not need to be straight, and may be arc-shaped along the outer periphery of the collector electrode ring.

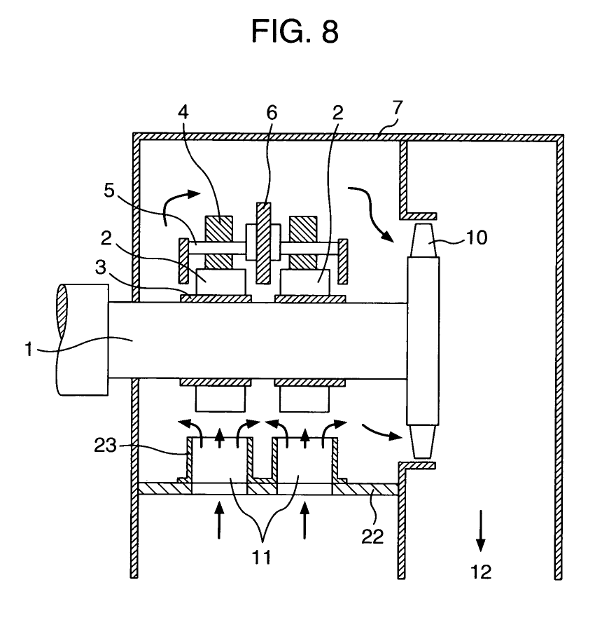

FIG. 8 is a drawing showing a comparative example. As shown in the drawing, a nozzle 23 of rectangular tubular shape is attached to the mounting plate 22. In this example, the cooling air is distributed into the circumferential and axial directions. Therefore, a cross sectional area for passing the flow is increased in comparison with the embodiment of FIG. 6 to decrease an average flow speed so that the effect by the jet flow cooling is decreased.

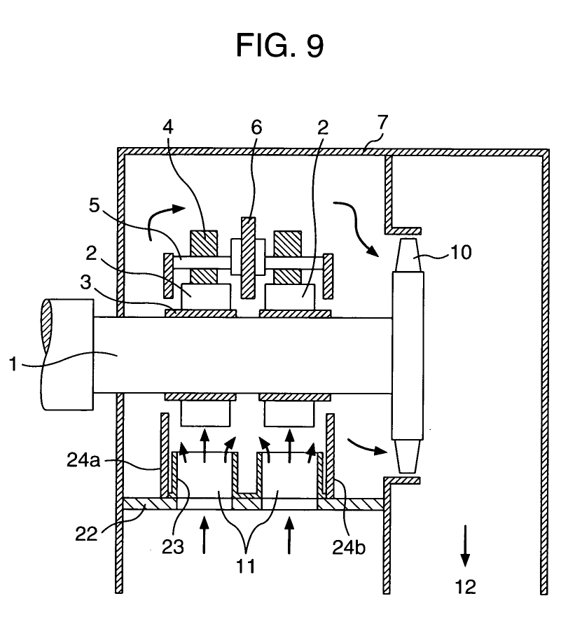

FIG. 9 is a drawing explaining another embodiment of the invention. In the embodiment of this drawing, control plates 24a and 24b for respective flows are arranged at axial outsides of the nozzles 23 shown in FIG. 8. The control plates 24a and 24b (a pair of plates constituting control plates 24 for controlling the axial flow) guides the major part of the flow flowing from the inlets 11 in the circumferential direction of the collector electrode rings 2 similarly to the flow control plates 20a and 20b shown in FIG. 6. Further, by forming the control plates 20, 24 in this way, the flow rate in the circumferential direction is increased in comparison with the axial direction so that the effect on the jet flow cooling is increased.

Incidentally, the technique in which the axial flow is controlled by the control plates 20 higher than the control plates 21 as shown in FIG. 6 and the technique in which the axial flow is controlled by the control plates 24 at the axial outsides of the nozzles, can be applied to the embodiments shown in FIGS. 1, 4 and 5.

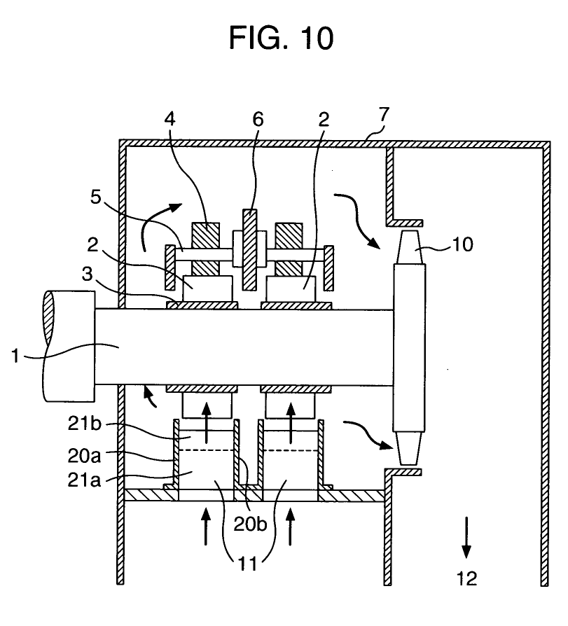

FIG. 10 is a drawing for explaining another embodiment of the invention (an example in which a technique in which the axial flow is controlled by the control plates 20 higher than the control plates 21 is applied to the embodiment of FIG. 1). Also in this embodiment, the major part of the flow flowing in from the inlet 11 is directed in the circumferential direction. Further, by the control plates 20a and 20b higher than the control plates 21a and 21b, the flow rate in the circumferential direction is increased in comparison with the axial direction so that the effect of the jet flow cooling is increased.

Incidentally, the cooling air sucked by the fan mounted on the rotor shaft is applied to the collector electrode rings in the above embodiments, on the other hand, the fan mounted at an upstream side of the inlet may blow out for the cooling. Further, two fans for suction and blowing-out respectively may be used.

It should be further understood by those skilled in the art that although the foregoing description has been made on embodiments of the invention, the invention is not limited thereto and various changes and modifications may be made without departing from the spirit of the invention and the scope of the appended claims.

1. A collector device for, with a cooling by a cooling medium, at lease one of supplying an electric power to a rotor of a motor from the collector device and supplying the electric power from the rotor of the motor to the collector device, comprising,
a collector electrode fixed to the rotor and having a cylindrical outer surface,
an electrically conductive brush contactable with the cylindrical outer surface of the collector electrode to transmit the electric power between the electrically conductive brush and the rotor through the collector electrode, and
a cooling medium outlet opening to at least partially face to the collector electrode in such a manner that the cooling medium is supplied from the outlet to the collector electrode in each of circumferential directions of the rotor opposed to each other circumferentially.

2. A collector device according to claim 1, wherein the outlet and the collector electrode are arranged in such a manner that a flow rate of the cooling medium supplied toward the collector electrode at a first side of the outlet from which first side the collector electrode is movable circumferentially toward a second side of the outlet opposite to the first side in the circumferential directions of the rotor is greater than a flow rate of the cooling medium supplied toward the collector electrode at the second side of the outlet toward which second side the collector electrode is movable circumferentially from the first side of the outlet.

3. A collector device according to claim 1, wherein the outlet and the collector electrode are arranged in such a manner that an opening area for a flow of the cooling medium between the outlet and the collector electrode in one of the circumferential directions at a first side of the outlet from which first side the collector electrode is movable circumferentially toward a second side of the outlet opposite to the first side in the circumferential directions of the rotor is greater than an opening area for the flow of the cooling medium between the outlet and the collector electrode in the other one of the circumferential directions at the second side of the outlet toward which second side the collector electrode is movable circumferentially from the first side of the outlet.

4. A collector device according to claim 1, wherein the outlet and the collector electrode are arranged in such a manner that a representative flow direction of the whole of the cooling medium flowing out of and directed by the outlet is prevented from passing a radial center of the rotor.

5. A collector device according to claim 1, wherein the outlet and the collector electrode are arranged in such a manner that a representative flow direction of the whole of the cooling medium flowing out of and directed by the outlet and a circumferential moving direction of the collector electrode at a circumferential position of the outer surface of the collector electrode which circumferential position is passed by the representative flow direction are opposed to each other.

6. A collector device according to claim 1, wherein a minimum distance in a radial direction of the rotor between the collector electrode and a part of the outlet facing to each other in the radial direction at a first side of the outlet from which first side the collector electrode is movable circumferentially toward a second side of the outlet opposite to the first side in the circumferential directions of the rotor is greater than a minimum distance in the radial direction between the collector electrode and another part of the outlet facing to each other in the radial direction at the second side of the outlet toward which second side the collector electrode is movable circumferentially from the first side of the outlet.

7. A collector device according to claim 1, wherein a distance in a radial direction of the rotor between the collector electrode and each of terminating ends of the outlet in an axial direction of the rotor is greater than a distance in the radial direction between the collector electrode and the outlet at an intermediate position of the outlet between the terminating ends in the axial direction at at least one of a first side of the outlet from which first side the collector electrode is movable circumferentially toward a second side of the outlet opposite to the first side in the circumferential directions of the rotor and the second side of the outlet toward which second side the collector electrode is movable circumferentially from the first side of the outlet.

8. A collector device according to claim 1, wherein the collector device comprises a pair of the collector electrodes and a pair of the outlets for the respective collector electrodes, and a distance in a radial direction of the rotor between the collector electrode and one of the outlets at one of terminating ends of the one of the outlets in an axial direction of the rotor is smaller than a distance in the radial direction between the collector electrode and each of the outlets at an intermediate position of the each of the outlets in the axial direction between the terminating ends of the each of the outlets in the axial direction at a side of the each of the outlets toward which side the collector electrode is movable circumferentially from a radially central position of the each of the outlets.

9. A collector device according to claim 9, wherein the one of terminating ends of the one of the outlets is arranged between two of the terminating ends of the outlets in the axial direction of the rotor.

10. A collector device according to claim 1, wherein in a cross sectional view of the outlet taken along an imaginary plane perpendicular to an axial direction of the rotor, the outlet has a first inner surface at a first side of the outlet from which first side the collector electrode is movable circumferentially toward a second side of the outlet opposite to the first side in the circumferential directions of the rotor and a second inner surface at the second side of the outlet toward which second side the collector electrode is movable circumferentially from the first side of the outlet, and when a distance between each of the first and second inner surfaces and a measuring location on an imaginary straight line passing a radially central position of the outlet and a rotary axis of the rotor is measurable in a distance measuring direction perpendicular to the imaginary straight line, a rate of increase in the distance between the first inner surface and the measuring location with respect to a decrease in distance between the measuring location and the outer surface of the collector electrode along the imaginary straight line is greater than a rate of increase in the distance between the second inner surface and the measuring location with respect to the decrease in distance between the measuring location and the outer surface of the collector electrode along the imaginary straight line.

11. A collector device according to claim 1, wherein the collector electrode and at least one of terminating ends of the outlet in an axial direction of the rotor overlap each other at least partially as seen in the axial direction of the rotor.

12. An electric motor for generating a rotary output power from an electric power supplied to the motor with a cooling by a cooling medium, comprising,
a rotor capable of being rotationally driven by the electric power to generate the rotary output power,
a collector electrode fixed to the rotor and having a cylindrical outer surface of the collector electrode,
an electrically conductive brush contactable with the cylindrical outer surface of the collector electrode to supply the electric power to the collector electrode, and
a cooling medium outlet opening to at least partially face to the collector electrode in such a manner that the cooling medium is supplied from the outlet to the collector electrode in each of circumferential directions of the rotor opposed to each other circumferentially.

13. An electric motor according to claim 12, wherein the outlet and the collector electrode are arranged in such a manner that a flow rate of the cooling medium supplied toward the collector electrode at a first side of the outlet from which first side the collector electrode is movable circumferentially toward a second side of the outlet opposite to the first side in the circumferential direction of the rotor is greater than a flow rate of the cooling medium supplied toward the collector electrode at the second side of the outlet toward which second side the collector electrode is movable circumferentially from the first side of the outlet.

14. An electric motor according to claim 12, wherein the outlet and the collector electrode are arranged in such a manner that an opening area for a flow of the cooling medium between the outlet and the collector electrode in one of the circumferential directions at a first side of the outlet from which first side the collector electrode is movable circumferentially toward a second side of the outlet opposite to the first side in the circumferential direction of the rotor is greater than an opening area for the flow of the cooling medium between the outlet and the collector electrode in the other one of the circumferential directions at the second side of the outlet toward which second side the collector electrode is movable circumferentially from the first side of the outlet.

15. An electric motor according to claim 12, wherein the outlet and the collector electrode are arranged in such a manner that a representative flow direction of the whole of the cooling medium flowing out of and directed by the outlet is prevented from passing a radial center of the rotor.

16. An electric motor according to claim 12, wherein the outlet and the collector electrode are arranged in such a manner that a representative flow direction of the whole of the cooling medium flowing out of and directed by the outlet and a circumferential moving direction of the collector electrode at a circumferential position of the outer surface of the collector electrode which circumferential position is passed by the representative flow direction are opposed to each other.

17. An electric motor according to claim 12, wherein a minimum distance in a radial direction of the rotor between the collector electrode and a part of the outlet facing to each other in the radial direction at a first side of the outlet from which first side the collector electrode is movable circumferentially toward a second side of the outlet opposite to the first side in the circumferential directions of the rotor is greater than a minimum distance in the radial direction between the collector electrode and another part of the outlet facing to each other in the radial direction at the second side of the outlet toward which second side the collector electrode is movable circumferentially from the first side of the outlet.

18. An electric motor according to claim 12, wherein a distance in a radial direction of the rotor between the collector electrode and each of terminating ends of the outlet in an axial direction of the rotor is greater than a distance in the radial direction between the collector electrode and the outlet at an intermediate position of the outlet between the terminating ends in the axial direction at at least one of a first side of the outlet from which first side the collector electrode is movable circumferentially toward a second side of the outlet opposite to the first side in the circumferential directions of the rotor and the second side of the outlet toward which second side the collector electrode is movable circumferentially from the first side of the outlet.

19. An electric motor according to claim 12, wherein the collector device comprises a pair of the collector electrodes and a pair of the outlets for the respective collector electrodes, and a distance in a radial direction of the rotor between the collector electrode and one of the outlets at one of terminating ends of the one of the outlets in an axial direction of the rotor is smaller than a distance in the radial direction between the collector electrode and each of the outlets at an intermediate position of the each of the outlets in the axial direction between the terminating ends of the each of the outlets in the axial direction at a side of the each of the outlets toward which side the collector electrode is movable circumferentially from a radially central position of the each of the outlets.

20. An electric motor according to claim 20, wherein the one of terminating ends of the one of the outlets is arranged between two of the terminating ends of the outlets in the axial direction of the rotor.

21. An electric motor according to claim 12, wherein in a cross sectional view of the outlet taken along an imaginary plane perpendicular to an axial direction of the rotor, the outlet has a first inner surface at a first side of the outlet from which first side the collector electrode is movable circumferentially toward a second side of the outlet opposite to the first side in the circumferential directions of the rotor and a second inner surface at the second side of the outlet toward which second side the collector electrode is movable circumferentially from the first side of the outlet, and when a distance between each of the first and second inner surfaces and a measuring location on an imaginary straight line passing a radially central position of the outlet and a rotary axis of the rotor is measurable in a distance measuring direction perpendicular to the imaginary straight line, a rate of increase in the distance between the first inner surface and the measuring location with respect to a decrease in distance between the measuring location and the outer surface of the collector electrode along the imaginary straight line is greater than a rate of increase in the distance between the second inner surface and the measuring location with respect to the decrease in distance between the measuring location and the outer surface of the collector electrode along the imaginary straight line.

22. An electric motor according to claim 12, wherein the collector electrode and at least one of terminating ends of the outlet in an axial direction of the rotor overlap each other at least partially as seen in the axial direction of the rotor.
